(19) United States
(12) Patent Application Publication
(10) Pub. No.: US 2007/0260857 A1
(43) Pub. Date: Nov. 8, 2007

(54) Electronic Circuit

(75) Inventors: Adrianus Josephus Bink, Eindhoven (NL); Mark Nadim Olivier De Clercq, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,583

(22) PCT Filed: Feb. 24, 2005
(86) PCT No.: PCT/IB05/50684

§ 371 Date: Sep. 5, 2006

(30) Foreign Application Priority Data
Mar. 10, 2004 (EP) 04100975.4

(51) Int. Cl. G06F 9/38

(52) U.S. Cl. 712/218; 712/E09.045

(57) ABSTRACT

There is provided an electronic circuit adapted to process a plurality of types of instruction, the electronic circuit comprising first and second pipeline stages and a latch positioned between the pipeline stages; wherein the electronic circuit is adapted to operate in a normal mode when processing a first type of instruction in which the latch is opened and closed in response to an enable signal, and a reduced mode when processing a second type of instruction in which the latch is held open so that the instruction propagates through the first and second pipeline stages without being stored in the latch; and wherein the first type of instruction requires processing by the first and second pipeline stages and the second type of instruction requires processing by the second pipeline stage.

### TECHNICAL FIELD OF THE INVENTION

The present invention relates to the field of electronic circuits, and in particular to electronic circuits having pipelines with variable latency in accessing a shared resource.

### BACKGROUND OF THE INVENTION

Many conventional electronic circuits, for example microprocessors, use ‘pipelines’ to increase parallelism and performance. That is, where instruction execution in a microprocessor comprises several independent steps, separate units can be created in the microprocessor to carry out each step. When a unit finishes executing an instruction, it is passed on to the next unit in the ‘pipeline’, and starts work on the next instruction. Therefore, although the length of time required for an entire instruction to be executed remains the same as in a non-pipelined system, as the next instruction is only one unit behind, the overall result is that the performance of the microprocessor is improved.

Unlike synchronous circuits in which a global clock signal controls how long a component processes data and when that data propagates to the next part of the system, components in a synchronous systems execute tasks at their own rate, and only move on to the next task when the next part of the system has acknowledged receipt of the data.

Therefore, as there is no global clock signal, it is necessary for components in a synchronous systems to use a handshaking protocol so that individual parts of the system can communicate with each other.

In one type of system, when a first stage requires a second stage to perform a computation, the first stage sends a request to the second stage. The second stage performs the computation and, when it has finished the computation, sends an acknowledge signal to the first stage. When the first stage receives the acknowledge signal, it knows that the computation has been completed and it can move on to the next instruction.

Alternative types of a synchronous systems are described in “MOUSETRAP: ultra high-speed transitional signalling a synchronous pipelines” by Singh M. and Nowick, S. M., Proceedings of the International Conference on Computer Design (ICCD) 2001, pages 9-17, “Micropipelines” by Sutherland, I.E., Communications of the ACM 1989 and in European Patent Application No. 03103399.6 entitled “Electronic circuit with a chain of processing elements”.

In a synchronous processors, the pipeline stages are generally implemented using latches.

The instructions within the instruction sets that pipelined processors usually implement often have different latencies. This means that instructions take different lengths of time to complete when they are executed in a sequential manner.

For example, consider an arithmetic computation (ALU) instruction and a load operation.

FIG. 1 shows a classic five-stage pipeline 2 having five stages with respective latches 4, 6, 8 and 10. CPU arithmetic and logical computations are performed in the execute stage (third stage). Load instructions use the third stage for address computation and the memory stage (fourth stage) for actually loading data from a memory, 12. In the write-back stage (fifth stage), the operation of writing back, either the results of the execute stage (third stage) or the data loaded from memory 12, into register file 14 takes place. Therefore, write-back for an ALU computation can, in principle, occur after the execute stage, whereas write-back for a load operation cannot occur earlier than after the memory stage (fourth stage). However, if both the result of the execute stage and that of the memory stage were allowed to write back to the register file 14 as soon as the results are available, a load followed by an ALU computation would lead to two simultaneous write-backs causing a contention on the register file resource 14.

This resource contention is presently solved in one of two ways. In the first approach, an additional write-port is added to the register file 14, allowing for two simultaneous write actions to occur in the register file 14. In FIG. 1, dashed line 16 represents the connection from the third latch 8 to the second write-port in the register file 14.

However, this approach is expensive from a hardware point of view. Also, in the case where both write actions are destined for the same location in the register file 14, some controlling circuitry must decide which value should be written back first.

The second approach (also shown in FIG. 1) forces the result of the ALU operation through an additional pipeline stage (i.e. it is stored in latch 10 after the result of the preceding operation has been passed to the register file 14) so that it requires the same write-back delay as load operations. This approach extends the delay of ALU operations to match those of load instructions, thus reducing the performance and increasing the power consumption of the pipeline. A further disadvantage of this approach is that even if results of the ALU operation could potentially be written to the register file 14 earlier (i.e. when no load instruction was preceding it in the pipeline), it is unable, as it must still propagate through the “additional” stage (latch 10).

There is therefore a need to prevent register file resource contention without requiring significant amounts of extra hardware, or increasing instruction latency.

### SUMMARY OF THE INVENTION

According to a first aspect of the present invention, there is provided an electronic circuit adapted to process a plurality of types of instruction, the electronic circuit comprising first and second pipeline stages; and a latch positioned between the pipeline stages; wherein the electronic circuit is adapted to operate in a normal mode when processing a first type of instruction in which the latch is opened and closed in response to an enable signal, and a reduced mode when processing a second type of instruction in which the latch is held open so that the instruction propagates through the first and second pipeline stages without being stored in the latch; wherein the first type of instruction requires processing by the first and second pipeline stages and the second type of instruction requires processing by the second pipeline stage.

According to another aspect of the present invention, there is provided a method of operating an electronic circuit, the electronic circuit being adapted to process a plurality of types of instruction, the electronic circuit comprising first and second pipeline stages and a latch positioned between the stages, the method comprising operating the electronic circuit in a normal mode when processing a first type of instruction in which the latch is opened and closed in response to an enable signal, and a reduced mode when processing a second type of instruction in which the latch is held open so that the instruction propagates through the first and second pipeline stages without being stored in the latch; wherein the first type of instruction requires processing by the first and second pipeline stages and the second type of instruction requires processing by the second pipeline stage.

### BRIEF DESCRIPTION OF THE DRAWINGS

For a better understanding of the present invention, and to show more clearly how it may be carried into effect, reference will now be made, by way of example, to the following drawings, in which:

FIG. 1 shows a conventional five-stage microprocessor pipeline;

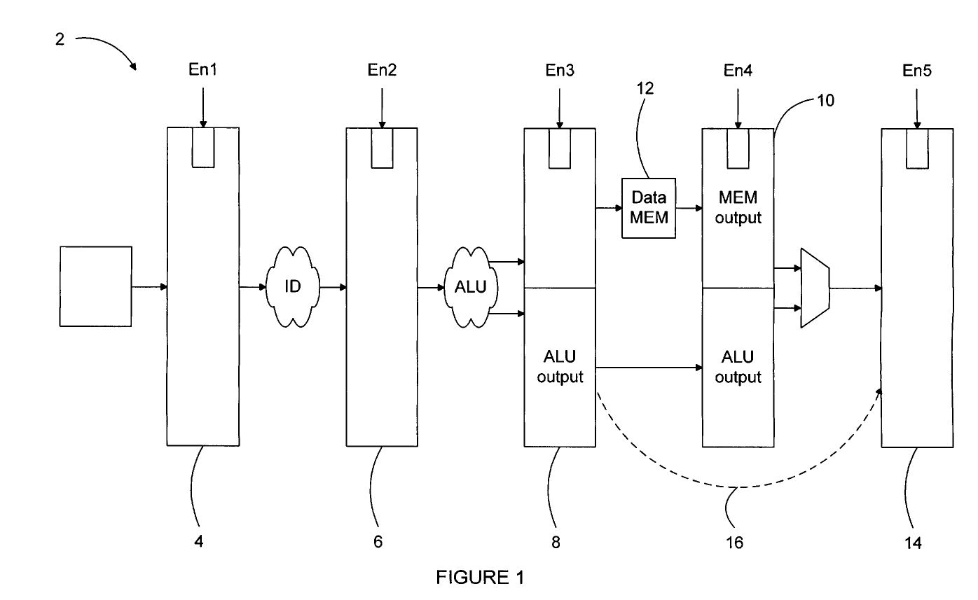

FIG. 2 shows a five-stage microprocessor pipeline according to the invention;

FIG. 3 shows one implementation of a pipeline latch controller according to the invention; and

FIG. 4 shows the operation of a five-stage pipeline according to the invention.

### DETAILED DESCRIPTION OF PREFERRED EMBODIMENTS

Although the present invention will be described below with reference to a pipeline in an a synchronous microprocessor, it will be appreciated that the present invention is applicable to any type of electronic circuit having a pipeline in which the problem of contention for a shared resource is solved by introducing delay into the processing of instructions with different latencies.

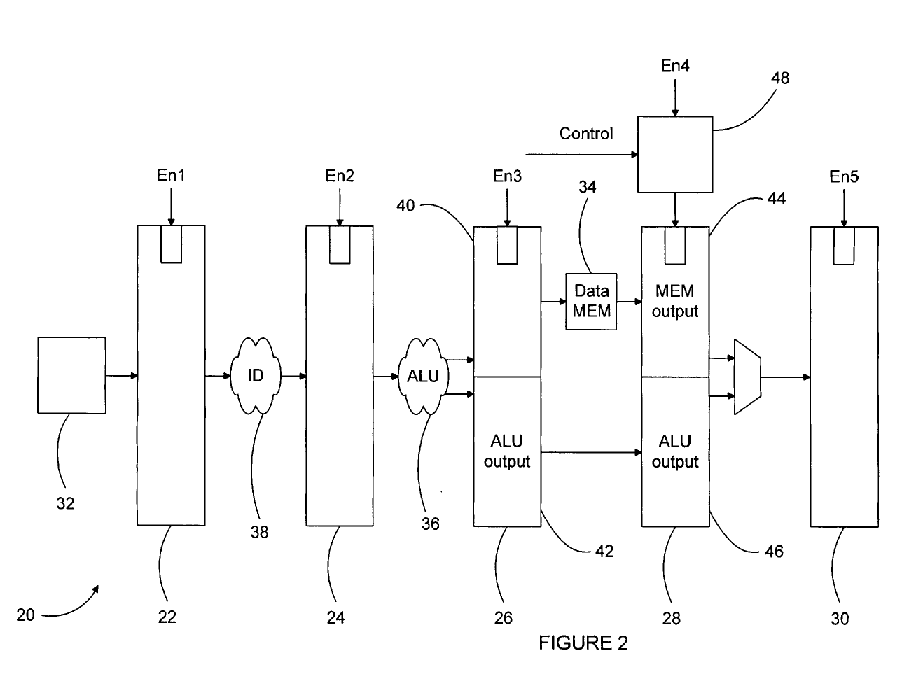

FIG. 2 shows a microprocessor pipeline according to the invention. In this illustrated embodiment, the microprocessor pipeline 20 is a five-stage pipeline, however, it will be appreciated that the invention is applicable to pipelines having more or fewer stages. Furthermore, the invention is described in relation to one specific handshaking protocol, although it will be appreciated that the invention is applicable to systems using other protocols.

The stages of the pipeline 20 each comprise a respective latch (22, 24, 26, 28 and 30), and as conventional, each latch has a respective enable signal, En1, En2, En3, En4 or En5, which determines the operating mode of the latch. When the latch is enabled, the output of the latch is the same as the input of the latch, and the latch is called transparent. When the latch is disabled, the output of the latch holds the last value at its input.

An instruction memory 32 is connected to the first latch 22, and this stores the instructions for the processor pipeline 20. The instructions may comprise load instructions, which are used to access a particular address in a data memory 34, arithmetic computation instructions, which are to be executed by an arithmetic and logic unit (ALU) 36, or may comprise other types of instructions, such as Compare, Jump, Branch and Store instructions.

As described above, the results of the load and arithmetic computation instructions are written to the fifth latch 30. However, the results of the Compare, Jump, Branch and Store instructions do not need to be written to the fifth latch 30, and their execution may be complete after the third or fourth stage.

The retrieved instruction is stored in the first latch 22, and is passed to a unit 38. The unit 38 is commonly known as the decode stage and decodes the retrieved instruction. The output of the unit 38, which may comprise control and data signals, is stored in the second latch 24, when the second latch 24 has received confirmation that any preceding instruction has been safely stored in the third latch 26. These control and data signals tell each stage of the pipeline which operation they should perform.

The instruction stored in the second latch 24 is then executed by ALU 36. If the instruction is an arithmetic computation instruction, the ALU 36 performs the computation. However, if the instruction is a load instruction, the ALU 36 calculates the address that must be accessed in the data memory 34 at the fourth stage of the pipeline 20. The result of the computation is then stored in a register 40 or 42 of the third latch 26 when the third latch 26 has received confirmation that the preceding instruction has been stored by the next stage. The particular register 40, 42 within the third latch 26 that stores the result is determined by the nature of the instruction being processed. For example, if the instruction is a load instruction, the result is stored in the top register 40 so that the data memory 34 can be accessed. Alternatively, if the instruction is an arithmetic instruction, the result is stored in the bottom register 42. In one implementation, the enable signal En3, in conjunction with conditional bits, allows the selection of the separate registers 40, 42.

In the case of Compare, Store, Jump or Branch instructions, the instruction is fully executed after completing the third stage, ALU 36, or fourth stage (depending on the particular instruction).

In the fourth stage, if the present instruction is a load instruction, the data memory 34 is accessed and the required data read out to the top register 44 of latch 28. If the present instruction is an arithmetic computation instruction, the result from the third stage (stored in latch 26) is now stored in the bottom register 46 of latch 28.

Although only two registers are shown in each of the third and fourth latches 26 and 28, it will be appreciated that there may be more than two, and the exact number will depend on the types of instructions that the pipeline can process.

In the fifth stage, the result of the fourth stage (stored in latch 28) is written into latch 30 (hereinafter referred to as the ‘register file’).

As described above, once an arithmetic computation instruction has been processed in the third stage, it is ready to be written into the register file 30. However, this will cause problems at the register file 30 if there is also data waiting to be written to the register file 30 in the fourth latch. As described above, the result of the computation instruction must be stored in the fourth latch while the data loaded by a preceding load instruction or generated by executing a preceding arithmetic instruction is written to the register file 30.

Of course, storing the result of the computation instruction in the fourth latch introduces delay into the processing of the arithmetic computation instructions.

Therefore, in accordance with the invention, where instructions with different latencies are issued (i.e. the instructions take different amounts of time to compute their final result), instructions can be accelerated through the pipeline 20 by allowing a selected latch or latches in the pipeline 20 to become transparent, effectively combining the two adjacent stages into one stage, thereby allowing the data to pass straight through to the next stage and removing the unnecessary delay in the data path.

As mentioned above, different ‘latencies’ means instructions that do not require the same amount of time to complete when executed in a sequential manner. For example, in the embodiment illustrated in FIG. 2, an arithmetic computation instruction has a latency of 4, as it does not need to pass through the fourth stage, and only needs to be executed by four of the five pipeline stages. However, a load instruction (or the data associated with it) needs to be stored by each of the five latches, and thus has a latency of 5.

Instructions such as the Compare, Branch and Jump instructions, which do not use the fifth stage, have a latency of 3. The Store instruction does need to use the fourth stage, but does not need to use the fifth (write-back) stage, and therefore has a latency of 4.

Therefore, in accordance with an aspect of the invention, storing the result of the computation instruction in the fourth stage latch is prevented by holding that latch in a transparent state, thereby allowing the result of the computation instruction to be written straight to the register file 30 after completing the third stage.

However, if the instruction is a load instruction, the instruction must be processed by all five stages, and the fourth stage cannot be held in a transparent mode. In addition, if an arithmetic computation instruction is preceded in the pipeline by a load instruction or other instruction that requires processing by all five pipeline stages (such as an earlier arithmetic instruction that has not been accelerated), the fourth stage cannot be skipped by that arithmetic computation and it must also be stored in the fourth stage.

Therefore, to control the operation of the fourth stage latch 28 in accordance with the invention, a latch control circuit 48 is provided. The latch control circuit 48 receives the fourth latch enable signal En4 and a control signal.

In alternative pipelines in which stages other than the fourth are redundant for particular instructions (which would depend upon the specific instruction being processed and/or the pipeline structure), the latch controller or further latch controllers can be connected to other pipeline latches.

The latch control circuit 48 acts to control the mode of operation of the fourth latch 28. If the instruction currently in the third stage latch 26 cannot be accelerated through the pipeline 20, (for example it is a load instruction and must retrieve data in the fourth stage, or it is an arithmetic instruction preceded by a load instruction or an instruction that requires processing by all five pipeline stages, such as an earlier arithmetic instruction that has not been accelerated) then the latch control circuit 48 causes the fourth latch 28 to be operated normally by the enable signal En4. That is, the enable signal En4 controls whether the latch is transparent (i.e. when it is loading the next data to be stored) or whether it is holding the last value at its input when the latch was last enabled.

However, when the instruction in the third stage can be accelerated through the pipeline (i.e. it is an instruction, for example an arithmetic instruction, that is preceded by an instruction that has been accelerated through the fourth stage or preceded by an instruction that does not require the fifth stage, e.g. a Compare instruction), the control signal holds the fourth latch in a transparent mode until another instruction is processed that requires the fourth stage of the pipeline. That is, the latch control circuit 48 overrides the enable signal En4, and holds the latch 28 in a transparent state.

The transparency of the latch 28 means that data provided from latch 26 will be sent straight to the fifth stage for writing into the register file 30, effectively skipping the fourth stage altogether.

A pipeline 20, having a mode in which one or more of the latches are held open, effectively rendering that stage transparent, is known as a reduced pipeline.

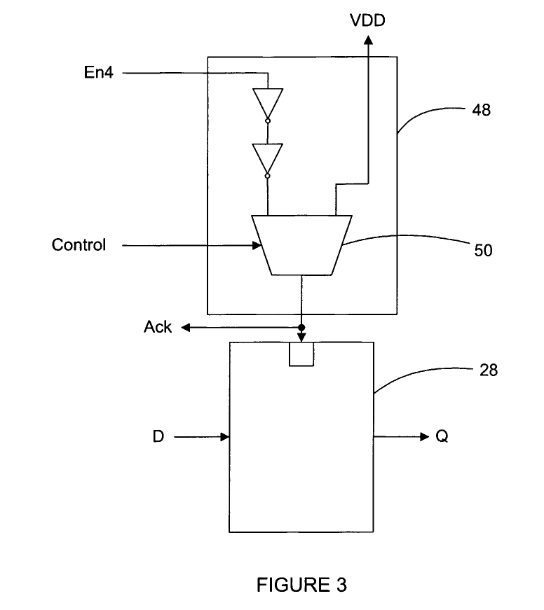

One implementation of a pipeline latch controller is shown in FIG. 3. The latch 28 is switched between a normal latching mode (in which it is controlled by the enable signal En4) and a reduced mode where it is kept transparent.

In this Figure, a high value of the enabling signal is translated into the latch 28 becoming transparent. However, the adaptation of this controller to the opposite situation, in which a low value of the enabling signal makes the latch transparent, will be readily apparent to a person skilled in the art.

In the latch controller 48, the switching between the reduced mode and a normal mode is determined by the control signal (Control). This signal controls the operation of a multiplexer 50, which has the enable signal En4 and a supply voltage signal VDD as its inputs.

If it is determined that the present instruction (for example an arithmetic instruction) is an instruction that can be accelerated through a pipeline stage, the control signal indicates that the latch 28 should be transparent, and the multiplexer 50 will be controlled by the control signal so that the VDD signal controls the operation of the latch 28. Therefore, the latch 28 will be forced into a transparent state, regardless of the value of the enable signal En4. However, when the instruction is an instruction that must be stored and processed by the fourth stage, the control signal operates the multiplexer 50 so that the enable signal is passed to the latch 28, allowing the instruction to be stored in the fourth latch as normal.

It will be appreciated that the latch control circuit described above and shown in FIG. 3 is exemplary and is merely one of many possible latch control circuits that may be used to implement the present invention. Many alternative types of latch control circuit will be readily apparent to a person skilled in the art.

Therefore, a latch with such a controller can be switched into a transparent mode whilst the other latches in the system can keep latching normally in response to their enable signals.

In this illustrated embodiment, the control signal is generated by determining the identity of the relevant instruction and the current state of the pipeline. This state will be either that acceleration through the fourth stage is occurring or not occurring. As described above, acceleration will not be occurring if the previous instruction was a load instruction or if a load instruction has been executed earlier and has not yet been followed by an instruction that does not use the write back (fifth) stage. Acceleration will be occurring if no load instruction has been executed yet, or if a load instruction has been executed but was subsequently (but not necessarily immediately) followed by an instruction that did not require the write-back (fifth) stage.

It will be appreciated that the timing of the control signal must be carefully controlled. If the fourth latch is switched into a transparent mode before any data in the fifth stage is written to the register file, that data will be lost. Therefore, the switching of any latch must be ‘safe’ with regard to the flow of data through the pipeline.

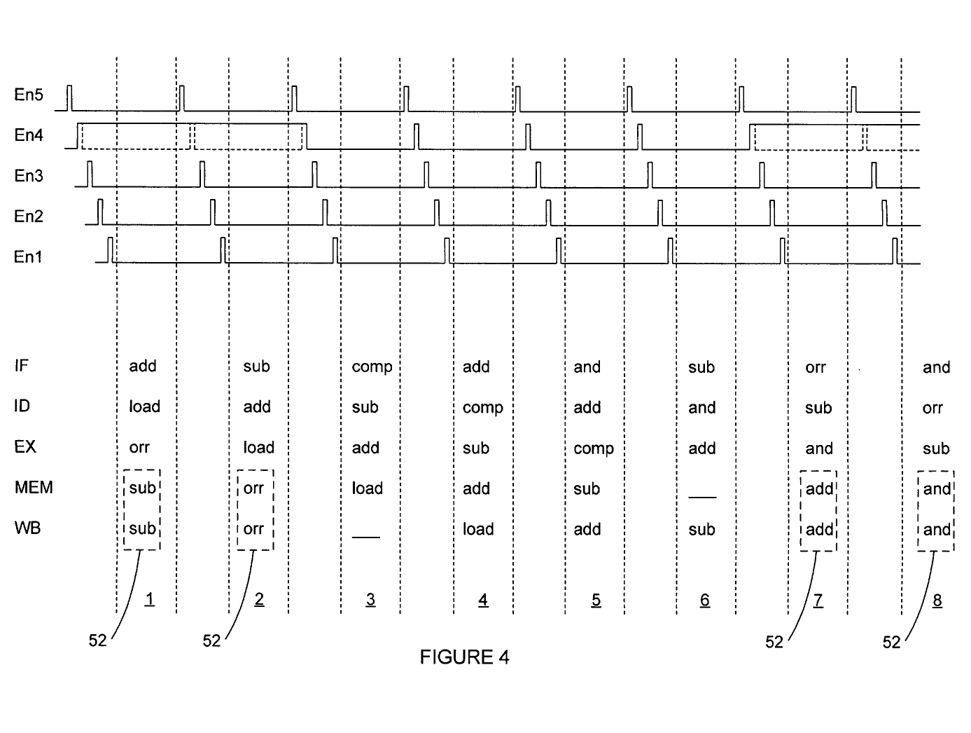

FIG. 4 shows the operation of an exemplary five-stage pipeline according to the invention.

In the top half of FIG. 4, the enable signals for each of the first, second, third, fourth and fifth latches are shown (En1, En2, En3, En4 and En5 respectively). The solid lines indicate the signals used to operate the latches. In the case of the first, second, third and fifth latches, these signals correspond to their respective enable signals, whilst in 5 the case of the fourth latch, this signal corresponds to the respective enable signal when the latch is operating in the normal mode, and is overridden with a ‘high’ signal when the latch is operating in the reduced or transparent mode. The dotted lines on En4 show the conventional enable signal for the fourth latch.

The bottom half of FIG. 4 shows the instructions present in a particular pipeline stage at a particular time. The first pipeline stage, the stage at which instructions are fetched from the instruction memory 32 and which precedes the first latch 22, is denoted IF. The second, third, fourth and fifth stages which precede the second, third, fourth and fifth latches respectively are denoted ID, EX, MEM and WB respectively.

In this exemplary pipeline, three different types of instruction are used. The first type of instruction requires execution by each of the five stages in the pipeline. A load instruction is one example of this type of instruction. The second type of instruction does not require execution by the fourth stage MEM, but does need to be written to the fifth latch. Arithmetic computation instructions, such as addition (add), subtraction (sub), logical or (orr) and logical and (and) are examples of the second type of instruction. The third type of instruction does not need to be written to the fifth latch after execution, and are fully processed after the third or fourth stages. Compare (comp), Jump, Branch and Store instructions are examples of the third type of instruction.

The bottom half of FIG. 4 shows how a set of instructions propagates through the pipeline in accordance with the invention. In this illustrated example, the instructions being processed occur in the following order: sub, orr, load, add, sub, comp, add, and, sub, orr, and.

In column 1, which shows the status of the pipeline during a first processing period, acceleration through the fourth latch is possible, as shown by the dashed box 52. Here, the ‘sub’ instruction in the fourth stage has propagated through to the fifth stage as the fourth latch is held in a transparent mode. It can be seen that enable signal En4 has been held ‘high’, thereby holding the fourth latch in the transparent state.

A similar situation can be seen in column 2 which represents the status of the pipeline in a second processing period. Here, the ‘orr’ instruction has propagated through the fourth and fifth stages.

However, as the next instruction following the ‘orr’ instruction is a ‘load’ instruction, and this uses the fourth stage to load the required data from memory 34, the fourth latch can no longer be held in a transparent mode. Therefore, during the transition from column 2 to column 3, the fourth latch is switched back into the normal mode, which can be seen from En4. Therefore, the ‘load’ instruction is stored in the third latch and the fourth latch and fifth stage are inactive during the third processing period.

In the fourth processing period, the ‘load’ instruction has passed into the fifth stage where its result is written to the register file.

In the fifth processing period, although the ‘load’ instruction has been fully executed by the pipeline, it is not yet possible to accelerate any subsequent instructions.

Specifically, the instructions following the ‘load’ instruction are ‘add’, ‘sub’, ‘comp’ and ‘add’. As the two instructions after the ‘load’ instruction are instructions of the second type (i.e. they do not need to pass through the fourth stage, but do need to be written to the register file) it is not possible to put the fourth latch back into the transparent mode yet. Therefore, in the fifth and sixth processing periods, the fourth latch is operated normally by En4.

However, as the next instruction ‘comp’ is of the third type (i.e. it does not need to be written to the fifth latch after execution, and is fully processed after the third or fourth stages) a ‘slot’ is created in the pipeline during the sixth processing period in the fourth stage (MEM). Therefore, this ‘slot’ allows the pipeline to be put back into a reduced state in which subsequent instructions can be accelerated through the fourth stage.

Consequently, in the transitional period between the sixth and seventh processing periods, the fourth latch enable signal is overridden with a ‘high’ signal which holds the fourth latch in the transparent state. Therefore, when the third latch is switched normally to receive the next instruction or computation result (the ‘add’ instruction) this instruction propagates through both the fourth and fifth stages as though they were a single stage. Again, this ‘single stage’ is indicated by dashed box 52.

The pipeline will continue to be in this reduced state until another ‘load’ instruction is processed.

The use of the present invention provides two significant advantages over conventional systems. The first advantage is that some write-backs to the register file can now occur earlier than in prior art processors, which, in other words, means that the speed of execution of some instructions is increased. This increases the performance of the microprocessor.

The second advantage is that, in the cases where a pipeline stage is reduced, there is no need to activate the latches of that stage during a processing cycle, and hence the power consumption of the chip is reduced.

It should be noted that the above-mentioned embodiments illustrate rather than limit the invention, and that those skilled in the art will be able to design many alternative embodiments without departing from the scope of the appended claims. The word ‘comprising’ does not exclude the presence of elements or steps other than those listed in a claim.

1. An electronic circuit adapted to process a plurality of types of instruction, the electronic circuit comprising:
first and second pipeline stages; and
a latch positioned between the pipeline stages;
wherein the electronic circuit is adapted to operate in a normal mode when processing a first type of instruction in which the latch is opened and closed in response to an enable signal, and a reduced mode when processing a second type of instruction in which the latch is held open so that the instruction propagates through the first and second pipeline stages without being stored in the latch;
wherein the first type of instruction requires processing by the first and second pipeline stages and the second type of instruction requires processing by the second pipeline stage.

2. An electronic circuit as claimed in claim 1, further comprising a latch control circuit connected to the latch, the latch control circuit being adapted to control the latch with the enable signal when the electronic circuit is in the normal mode, and to hold the latch open when the electronic circuit is in the reduced mode.

3. An electronic circuit as claimed in claim 2, wherein the latch control circuit receives a signal indicating the mode of operation of the electronic circuit.

4. An electronic circuit as claimed in claim 1, wherein the electronic circuit is adapted to process a third type of instruction, wherein the third type of instruction does not require processing by the second pipeline stage.

5. An electronic circuit as claimed in 4, wherein the electronic circuit is adapted to operate in the normal mode until an instruction of the third type is processed.

6. An electronic circuit as claimed in claim 5, wherein, after the instruction of the third type is processed, the electronic circuit is adapted to operate in the reduced mode if the following instruction is of the second or third type.

7. An electronic circuit as claimed in claim 4, wherein the electronic circuit is adapted to operate in the reduced mode until an instruction of the first type is processed.

8. An electronic circuit as claimed in claim 1, wherein the first type of instruction includes a load instruction.

9. An electronic circuit as claimed in claim 1, wherein the second type of instruction includes an arithmetic computation instruction.

10. An electronic circuit as claimed in claim 4, wherein the third type of instruction includes compare, store, branch and jump instructions.

11. An electronic circuit as claimed in claim 1, wherein the first pipeline stage comprises a data memory.

12. An electronic circuit as claimed in any claim 1, wherein the second pipeline stage comprises a write back stage.

13. A method of operating an electronic circuit, the electronic circuit being adapted to process a plurality of types of instruction, the electronic circuit comprising first and second pipeline stages and a latch positioned between the stages, the method comprising: operating the electronic circuit in a normal mode when processing a first type of instruction in which the latch is opened and closed in response to an enable signal, and a reduced mode when processing a second type of instruction in which the latch is held open so that the instruction propagates through the first and second pipeline stages without being stored in the latch;
wherein the first type of instruction requires processing by the first and second pipeline stages and the second type of instruction requires processing by the second pipeline stage.

14. A method as claimed in claim 13, wherein the electronic is further adapted to process a third type of instruction, wherein the third type of instruction does not require processing by the second pipeline stage.

15. A method as claimed in claim 14, further comprising the step of operating the electronic circuit in the normal mode until an instruction of the third type is processed.

16. A method as claimed in claim 15, wherein, after processing the instruction of the third type, the method further comprises the step of operating the electronic circuit in the reduced mode if the following instruction is of the second or third type.

17. A method as claimed in claim 14, further comprising the step of operating the electronic circuit in the reduced mode until an instruction of the first type is processed.

18. A method as claimed in claim 13, wherein the first type of instruction includes a load instruction.

19. A method as claimed in claim 13, wherein the second type of instruction includes an arithmetic computation instruction.

20. A method as claimed in claim 14, wherein the third type of instruction includes compare, store, branch and jump instructions.
